(19) United States
(12) Patent Application Publication
(10) Pub. No.: US 2021/0016117 A1
(43) Pub. Date: Jan. 21, 2021

(54) WILD FIRE PREVENTION APPARATUS

(71) Applicant: John Jackson, III, Hendersonville, NC (US)

(72) Inventor: John Jackson, III, Hendersonville, NC (US)

(21) Appl. No.: 16/517,639

(22) Filed: Jul. 21, 2019

(51) Int. Cl. A62C 3/02; A62C 35/58; A62C 37/36

(52) U.S. Cl. CPC A62C 3/02; A62C 37/04; A62C 35/58

(57) ABSTRACT

An apparatus for preventing wild fires is presented. The apparatus has a perimeter pipe for carrying water on the perimeter of a forest area. The apparatus also has a plurality of interior pipes coupled to the perimeter pipes. The plurality of interior pipes provide water to the interior of the forest area. The apparatus has a plurality of sensors that are collocated with the perimeter pipe determine information and environmental conditions. The apparatus has a control center coupled to the plurality of sensors for receiving the information and the conditions from the plurality of sensors. The apparatus further has a water source coupled to the perimeter pipe by an output pipe. The water source provides water in the output pipe to the perimeter pipe for distribution to the plurality of interior pipes. The water is then distributed to the forest area.

### FIELD OF THE INVENTION

This invention relates to wild fire prevention. More particularly, it relates to apparatus for preventing wild fires.

### BACKGROUND

A wildfire or wildland fire is a fire in an area of combustible vegetation occurring in rural areas. Depending on the type of vegetation present, a wildfire can also be classified more specifically as a brush fire, bushfire, desert fire, forest fire, grass fire, hill fire, peat fire, vegetation fire, and veld fire.

Fossil charcoal indicates that wildfires began soon after the appearance of terrestrial plants 420 million years ago. Wildfire's occurrence throughout the history of terrestrial life invites conjecture that fire must have had pronounced evolutionary effects on most ecosystems' flora and fauna. Earth is an intrinsically flammable planet owing to its cover of carbon-rich vegetation, seasonally dry climates, atmospheric oxygen, and widespread lightning and volcanic ignitions.

Wildfires can be characterized in terms of the cause of ignition, their physical properties, the combustible material present, and the effect of weather on the fire. Wildfires can cause damage to property and human life, though naturally occurring wildfires may have beneficial effects on native vegetation, animals, and ecosystems that have evolved with fire. High-severity wildfire creates complex early seral forest habitat (also called “snag forest habitat”), which often has higher species richness and diversity than unburned old forest. Many plant species depend on the effects of fire for growth and reproduction. Wildfires in ecosystems where wildfire is uncommon or where non-native vegetation has encroached may have strongly negative ecological effects. Wildfire behavior and severity result from the combination of factors such as available fuels, physical setting, and weather. Analyses of historical meteorological data and national fire records in western North America show the primacy of climate in driving large regional fires via wet periods that create substantial fuels or drought and warming that extend conducive fire weather.

Strategies for wildfire prevention, detection, and suppression have varied over the years. One common and inexpensive technique is controlled burning, intentionally igniting smaller fires to minimize the amount of flammable material available for a potential wildfire. Vegetation may be burned periodically to maintain high species diversity and limit the accumulation of plants and other debris that may serve as fuel. Wildland fire use is the cheapest and most ecologically appropriate policy for many forests. Fuels may also be removed by logging, but fuels treatments and thinning have no effect on severe fire behavior when under extreme weather conditions. Wildfire itself is consider to be the most effective treatment for reducing a fire's rate of spread, fireline intensity, flame length, and heat per unit of area. Building codes in fire-prone areas typically require that structures be built of flame-resistant materials and a defensible space be maintained by clearing flammable materials within a prescribed distance from the structure.

Preventing wild fires has been at the top of many lists. The methods and apparatus used currently have proved to be unsuccessful. Therefore, an apparatus that can help to prevent wild fires is a great need.

### BRIEF DESCRIPTION OF THE DRAWINGS

FIG. 1 is an illustrated view of an exemplary wild fire prevention apparatus.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

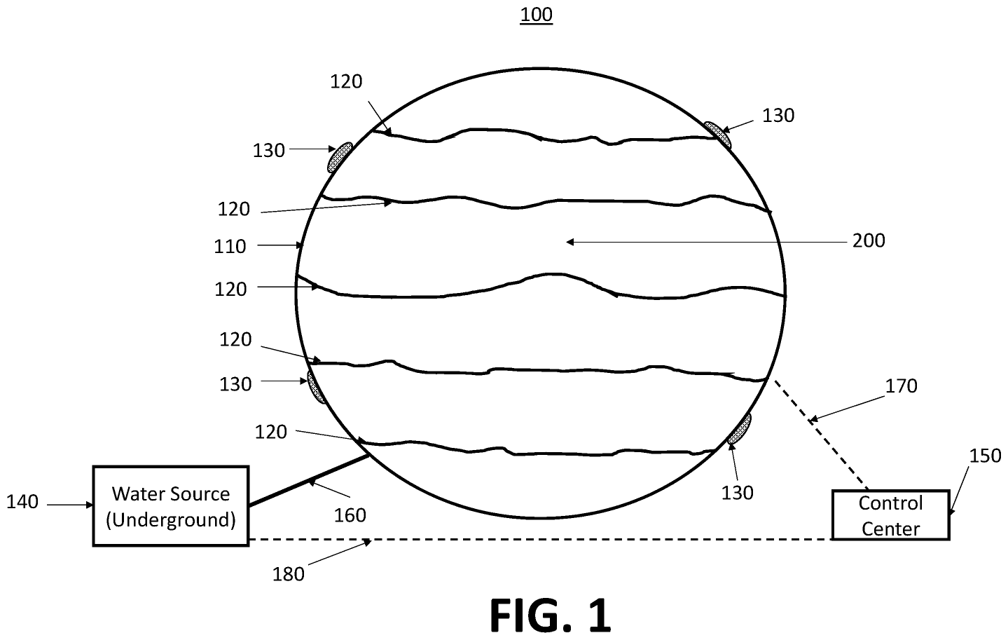

Referring to FIG. 1, an illustrated view of an exemplary wild fire prevention apparatus 100 is presented. The wild fire prevention apparatus 100 is useful in preventing wild fires by detecting, based on well known standards, the potential for wild fires and adjusts environmental concerns to prevent a wild fire from occurring.

The wild fire prevention apparatus 100 is preferably a subsection of a forest area 200, but may be the size of the entire forest area 200.

The apparatus 100 has a perimeter pipe 110, a plurality of interior pipes 120, a plurality of sensors 130 a water source 140 and a control center 150.

The perimeter pipe 110 is preferably made from copper, but may be made of any material which can withstand high temperatures and carry water, such as aluminum, steel, PVC, etc. The shape of the perimeter pipe 110 is preferably round but may be any shape desired, such as square, rectangular, hexagonal, trapezoidal, etc. The shape may be determined by the area that is desired to be covered by the apparatus 100.

The perimeter pipe 110 is placed around the perimeter of the area to be protected by the apparatus 100. The perimeter pipe 110 carries water to the plurality of interior pipes 120 and may optionally spray water over at least a portion of the protected area.

The interior pipe 120 is preferably made from copper, but may be made of any material which can withstand high temperatures and carry water, such as aluminum, steel, PVC, etc. The shape of the interior pipe 120 is preferably straight but may be any shape desired, such as square, rectangular, hexagonal, trapezoidal, etc. The shape may be determined by the area that is desired to be covered by the apparatus 100. The interior pipe 120 is coupled to the perimeter pipe 110 and is contained inside of the perimeter of the protected area.

The plurality of sensors 130 are coupled to the perimeter pipe 110, but may optionally be placed within the protected area and collocated with at least one of the plurality of interior pipes 120.

The plurality of sensors 130 are intelligent sensors which can detect or sense environmental conditions such as dryness of air, dryness of soil, etc. The plurality of sensors 130 determines the environmental conditions and transmits the conditions to the control center 150 via a communicative coupling 170. The communicative coupling 170 is preferably a wireless transmission but may be wired, satellite, etc.

The control center 150 receives the information about the conditions and location of each of the plurality of sensors 130. The control center 150 may have a display (not shown) to display the conditions on a map, in words, in a chart, etc. to a person monitoring the control center 150. When the conditions are ripe for wild fires, or preferably prior to the conditions being ripe, the control center 150 is in communication coupling 180 with the water source 140. The communicative coupling 180 may be a hard wire, wireless, satellite, etc.

The water source 140 receives the information and commands from the control center 150 via the communicative coupling 180 and prepares to provide water to the perimeter pipe 110 by the output pipe 160.

The output pipe 160 is preferably made from copper, but may be made of any material which can withstand high temperatures and carry water, such as aluminum, steel, PVC, etc. The shape of the output pipe 160 is preferably straight but may be any shape desired, such as square, rectangular, hexagonal, trapezoidal, etc. to be coupled to the perimeter pipe 110.

When the plurality of sensors 130 determine that the standards for wild fire conditions are no longer met, the plurality of sensors 130 transmits the information and conditions to the control center 150 via the communicative coupling 170.

After the control center 150 receives the information and conditions transmitted from the plurality of sensors 130, the control center 150 transmits a command to the water source 140 via the communicative coupling 180 to turn the system off.

The water source 140 receives the transmission from the control center 150 via the communicative coupling 180 and shuts off the water being provided to the perimeter pipe 110 via the output pipe 160.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An apparatus for preventing wild fires, the apparatus comprising:
a perimeter pipe, the perimeter pipe for carrying water on the perimeter of a forest area;
a plurality of interior pipes, the plurality of interior pipes being coupled to the perimeter pipes, wherein the plurality of interior pipes being for providing water to the interior of the forest area;
a plurality of sensors, the plurality of sensors being collocated with the perimeter pipe, wherein the plurality of sensors for determining information and environmental conditions;
a control center, the control center being communicatively coupled to the plurality of sensors, wherein the control center receiving the information and the conditions from the plurality of sensors; and
a water source, the water source being coupled to the perimeter pipe by an output pipe, wherein the water source providing water in the output pipe to the perimeter pipe for distribution to the plurality of interior pipes, and wherein the water being distributed to the forest area.

2. The apparatus of claim 1, wherein the forest area being a portion of the forest.

3. The apparatus of claim 1, wherein the perimeter pipe being made of copper material.

4. The apparatus of claim 1, wherein the plurality of interior pipes being made of copper.

5. The apparatus of claim 1, wherein the perimeter pipe further dispels water on at least a portion of the forest area.

6. The apparatus of claim 1, wherein the plurality of sensors transmits information and conditions to the control center by wireless transmission.

7. The apparatus of claim 1, wherein the control center transmits commands to the water source by wireless transmission.

8. The apparatus of claim 1, wherein the apparatus being a round shape.

9. The apparatus of claim 1, wherein when the conditions do not meet a standard for wild fire conditions, the control center transmitting a command to the water source to cease providing water to the perimeter pipe.

10. The apparatus of claim 1, wherein the environmental conditions being dryness of soil.

11. The apparatus of claim 1, wherein the control center further comprising:
a display panel, the display panel for displaying the information from the plurality of sensors.

12. The apparatus of claim 11, wherein the display panel displaying the information and conditions by a map.

13. The apparatus of claim 11, wherein the display panel displaying the information in word form.

14. The apparatus of claim 1, wherein the output pipe being made of a copper material.
